(19) United States
(12) Patent Application Publication
(10) Pub. No.: US 2017/0027131 A1
(43) Pub. Date: Feb. 2, 2017

(54) DOG LOCKER/PET LOCKER

(71) Applicant: Chelsea W. Brownridge, Brooklyn, NY (US)

(72) Inventor: Chelsea W. Brownridge, Brooklyn, NY (US)

(21) Appl. No.: 15/067,052

(22) Filed: Mar. 10, 2016

Related U.S. Application Data
(60) Provisional application No. 62/137,664, filed on Mar. 24, 2015.

(51) Int. Cl. A01K 1/03; A01K 1/00; A01K 1/035; G07C 9/00; A01K 29/00

(52) U.S. Cl. CPC A01K 1/034; G07C 9/00111; G07C 9/00896; A01K 29/005; A01K 1/0356; A01K 1/0076; A01K 1/0052

(57) ABSTRACT

A structure and method for providing a locker system for pets, where the locker is controlled by a software system and has a communication system for outside control. The locker monitors a pet therein and has a multitude of comfort elements. The locker may be remotely controlled using a mobile application which is in communication with the locker and which can be used for accessing and controlling the locker.

### CROSS REFERENCE TO PREVIOUS APPLICATIONS

This application claims the priority of provisional application No. 62/137,664 filed on 24 Mar. 2015 in the United States Patent and Trademark Office, which is fully incorporated herein by reference.

### BACKGROUND OF THE INVENTION

Field of the Invention

The present invention relates to an animal storage system, and more particularly, a DOG LOCKER/PET LOCKER.

Description of the Prior Art

Numerous innovations for lockers have been provided in the prior art that will be described. Even though these innovations may be suitable for the specific individual purposes to which they address, however, they differ from the present invention.

A FIRST EXAMPLE, U.S. Pat. No. 8,253,533, Published/Issued on Aug. 28, 2012, to Jones teaches a system for managing a plurality of lockers proximate a theme park attraction, the system having an electronically actuated lock disposed on the plurality of lockers, a guest identifier carriable on the guests person, the identifier usable as an electronic key configured to lock and unlock the lock, an egress sensor positioned at an exit of the theme park attraction and a processor in communication with the lock and the egress sensor and configured to unlock the lock subsequent to being signaled by the egress sensor. A method for using and managing a plurality of lockers is also described.

A SECOND EXAMPLE, U.S. Patent Office Document No. 20040031446, Published/Issued on Feb. 19, 2004, to Harrison teaches a modular kennel system, each module including a floor tub having a sloped floor and a gutter formed therein that is supported at a level above the surface on which the system rests for draining wastes therefrom. The system is erected on site without modification of the site in a variety of configurations and sizes and with or without a second level of enclosures. Each module comprising the system includes a substantially vertical panel from which the floor tub is supported and the drain basin formed in the gutter of the floor tub is connected through a plumbing trap to a drainpipe that runs between the module and the next adjacent module to connect the drain basins of the gutters from successive modules. This structure of the modular kennel system prevents cross-contamination, including sewer gases, between enclosures. The system may also include manual, timed, or conductivity-controlled flush systems for ridding the enclosures of waste fluids under a grate that is easy to clean. The kennel system may also include a ventilation system for insuring fresh air in the enclosure(s) in each module. Flushing and ventilation provides a healthy, dry environment for the animals housed within the enclosures comprising the modular kennel system.

A THIRD EXAMPLE, U.S. Patent Office Document No. 20130068172, Published/Issued on Mar. 21, 2013, to Hoegh, et al. teaches an invention which seeks to prevent damage to property resulting from an animal's separation anxiety which occurs when a pet owner departs, while minimizing the period of time the dog is confined. The device incorporates an automatically releasing door of a kennel or leash. For instance, the owner of a canine can place the dog in a kennel prior to leaving his or her residence. The owner can initiate a timer on the kennel or leash, and the kennel door opens or leash releases after a pre-determined amount of time, such as 30 minutes.

A FOURTH EXAMPLE, U.S. Patent Office Document No. 20140035721, Published/Issued on Feb. 6, 2014, to Heppe, et al. teaches a system and/or method for accessing a locker are provided. In some aspects, a method may include receiving, from a server, a password for accessing a locker, where the locker meets a set of requirements. The method may also include transmitting, to a computing device associated with the locker, the password for facilitating unlocking the locker. The method may also include receiving, from the computing device associated with the locker, a first confirmation message that the locker has been unlocked. The method may also include transmitting, to the server, a second confirmation message indicating that the locker has been unlocked in response to the first confirmation message.

A FIFTH EXAMPLE, Norwegian company Den4Dogs whose website was retrieved Mar. 7, 2016 discloses their main product is the “Den4Dogs Shopper”. This is a high quality product that is placed outside shoppingmalls, grocery stores, supermarkets, convenient stores—generally places where it is practical to drop by for some shopping while you're out walking your dog. You can safely place your dog in the Den4Dogs Shopper, so it can relax there while you are inside doing errands.

It is apparent now that numerous innovations for temporary animal storage have been provided in the prior art that adequate for various purposes. Furthermore, even though these innovations may be suitable for the specific individual purposes to which they address, accordingly, they would not be suitable for the purposes of the present invention as heretofore described.

### SUMMARY OF THE INVENTION

AN OBJECT of the present invention is to provide a DOG LOCKER/PET LOCKER that avoids the disadvantages of the prior art.

ANOTHER OBJECT of the present invention is to provide a DOG LOCKER/PET LOCKER that is simple and inexpensive to manufacture.

STILL ANOTHER OBJECT of the present invention is to provide a DOG LOCKER/PET LOCKER that is simple to use.

BRIEFLY STATED, STILL YET ANOTHER OBJECT of the present invention is to provide a DOG LOCKER/PET LOCKER that is available in convenient locations so that persons may keep their pets safely outside of establishments which prohibit animals therein.

The novel features which are considered characteristic of the present invention are set forth in the appended claims. The invention itself, however, both as to its construction and its method of operation, together with additional objects and advantages thereof, will be best understood from the following description of the specific embodiments when read and understood in connection with the accompanying drawing.

### BRIEF DESCRIPTION OF THE DRAWING

The figures of the drawings are briefly described as follows:

FIG. 1 is a diagrammatic perspective view showing a pair of side by side dog lockers with one in use;

FIG. 2 is a diagrammatic perspective view showing a pair of vertically stacked dog lockers with one in use;

FIG. 3 is a diagrammatic image of a first screen of mobile application for use with the present invention, for setting up an account;

FIG. 4 is a diagrammatic image of a second screen of mobile application for use with the present invention, for reserving a locker;

FIG. 5 is a diagrammatic image of a third screen of mobile application for use with the present invention, for seeing the status of a locker in use;

FIG. 6 is a diagrammatic image of a fourth screen of mobile application for use with the present invention, for allowing locking or unlocking of a locker;

FIG. 7 is a diagrammatic image of a fifth screen of mobile application for use with the present invention, for displaying information about the animal in a locker to a user;

FIG. 8 is a diagrammatic image of a sixth screen of mobile application for use with the present invention, for reporting feedback on a locker;

FIG. 9 is a diagrammatic image of a seventh screen of mobile application for use with the present invention, for an emergency alert;

FIG. 10 is a diagrammatic image of a eighth screen of mobile application for use with the present invention, for seeing an account status;

FIG. 11 is a diagrammatic image of a ninth screen of mobile application for use with the present invention, for displaying a reminder alert;

FIG. 12 is a block diagrammatic representation of a user control panel of the present invention;

FIG. 13 is a block diagrammatic representation of selected electronic components of a set of a locker of the present invention;

FIGS. 14-A and 14-B are a flow chart illustrating a method of using the components of the invention to access a locker by a user;

FIGS. 15-A and 15-B are a flow chart of a second embodiment illustrating a second method of using the components of the invention to access a locker by a user; and

FIGS. 16-A and 16-B are a flow chart of a third embodiment illustrating a third method of using the components of the invention to access a locker by a user.

### A MARSHALING OF REFERENCE NUMERALS UTILIZED IN THE DRAWING

10 locker system for pets
12 locker
14 software system
16 chamber of locker 12
18 locking mechanism of locker 12
20 user interface of locker 12
22 communication system of locker 12
24 user
28 computer of locker 12
30 monitoring elements of locker 12
32 pet
34 outputs of monitoring elements 30 of locker 12
36 microphone
38 scale
40 camera
42 thermometer
44 GPS locator
46 bark detector
48 motion detector
50 door closure detector
52 comfort elements of locker 12
54 treat dispenser
56 self cleaner
58 interior lights
60 exterior lights
62 heater
64 cooling fan
66 air conditioner
68 ultraviolet light
70 speaker
72 user control panel
74 input of user control panel 72
76 display of user control panel 72
78 server of locker system 10
80 mobile application
84 mobile communications device
86 reservation
88 verification system of mobile application 80
90 code of mobile application 80
92 short range communications device of user interface 20 of locker 12
94 pressure sensor
96 first communication system
98 second communication system
100 wired internet connection
102 wireless internet connection
104 power supply
106 power source
108 backup battery
210 method of using a locker system for pets
212 reserving a time period of use of locker 12
214 user 24 identifying themselves via user interface 20
216 user 24 opening locker 12 and inserting pet 32 therein
218 user 24 closing locker 12
220 user 24 returning at a later time to locker 12
222 user 24 verifying identity again
224 user 24 retrieving their pet 32
226 previously known member
228 password
230 keyfob
232 calling server 78
234 rating locker 12
236 monitoring pet 32 in locker 12
240 non-member
242 human supervisor
244 pre-arranged reservation
246 impromptu reservation

### DETAILED DESCRIPTION OF THE PREFERRED EMBODIMENT

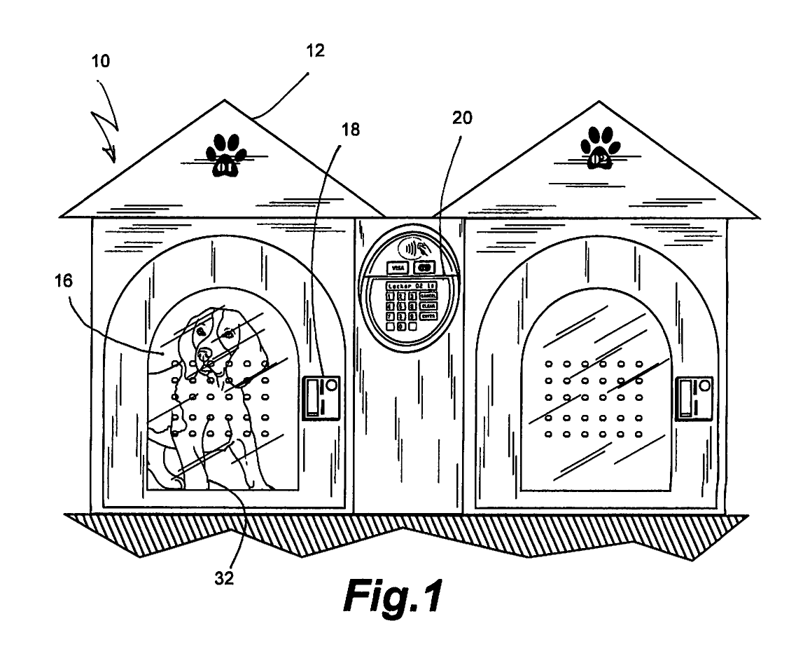

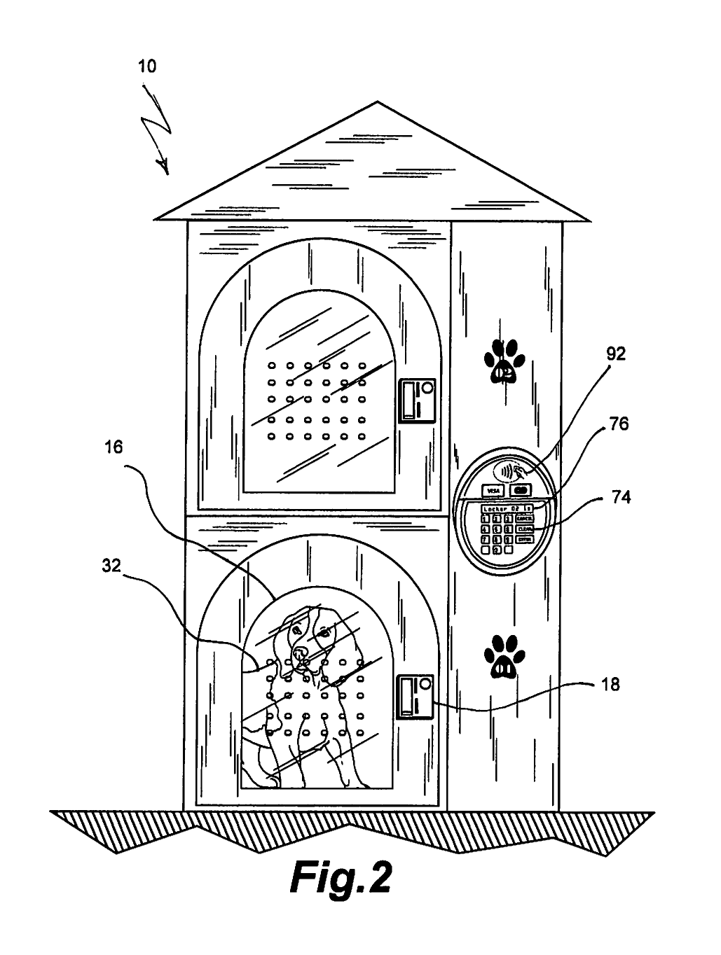

Referring now to the figures, in which like numerals indicate like parts, and particularly to FIGS. 1 and 2, disclosed is a locker system for pets 10 which constitutes a locker 12 and a software system 14. The locker 12 in turn constitutes:

a) at least one chamber 16;

b) a locking mechanism 18;

c) a user interface 20; and

d) a communication system 22.

The at least one chamber 16 is lockable by the locking mechanism 18. In turn, the locking mechanism 18 is controlled by the software system 14. To operate the locker system 10 a user 24 may interface with the software system 14 via the user interface 20. The communication system 22 is for communication between the locker 12 and the outside world via the software system 14 which is capable of communication with the outside world. As is illustrated in FIGS. 1 and 2, there may be more than one locker 12 which share certain elements such as the user interface 20 in common.

### Detailed Description of the Locker 10 and Software System 14.

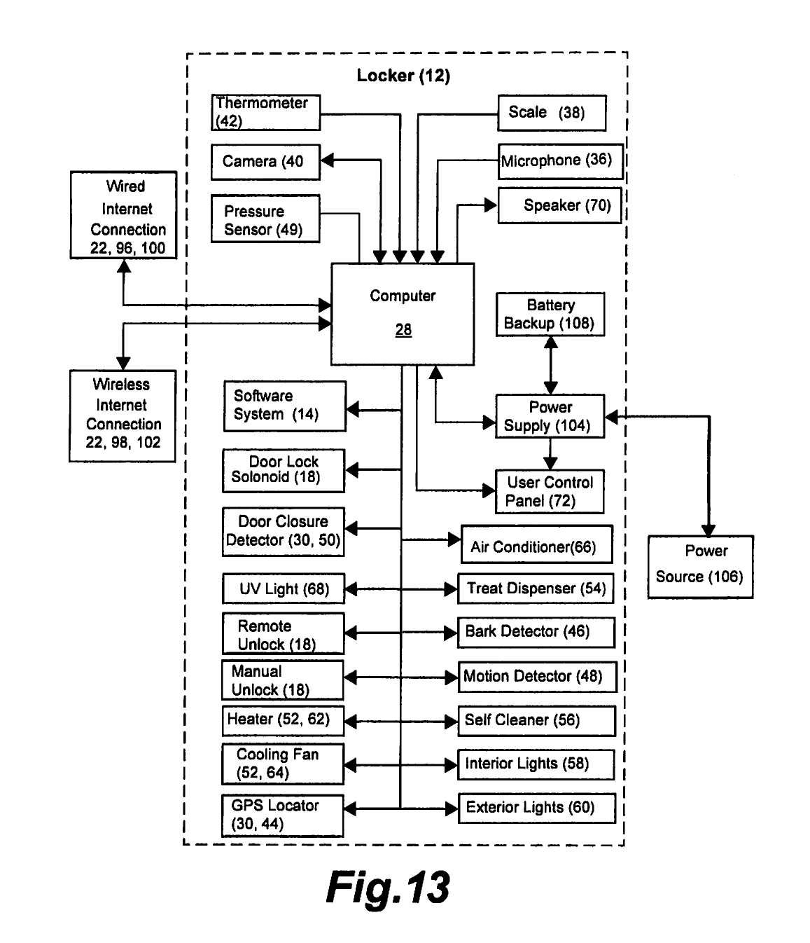

As described and shown in FIGS. 12 and 13, the locker further constitutes a computer 28. The software system 14 controls the computer 28. The computer 28 is electronically connected to and controls the locking mechanism 18. The locking mechanism 18 is also capable of manual override. The computer 28 is capable of being controlled remotely from the outside world via the communication system 22, while concurrently the computer is also capable of being controlled locally via a user 24 interfacing with the user interface 20.

The locker system further constitutes a set of monitoring elements 30. The monitoring elements are for monitoring a pet 32 inside of the chamber 16 of the locker 12. The set of monitoring elements 30 are in electronic communication with the computer 28. The set of monitoring elements 30 produce outputs 34, and the software system 14 controlling the computer 28 is capable of communicating the outputs 34 of the monitoring elements 30 to the outside world.

In the preferred embodiment, the monitoring elements 30 constitute at least one of:

a) a microphone 36;

b) a scale 38; c) a camera 40;

d) a thermometer 42;

e) a Global Positioning System (GPS) locator 44;

f) a bark detector 46;

g) a motion detector 48;

h) a pressure sensor 94; and

i) a door closure detector 50.

These elements may be used individually or in tandem. In the preferred embodiment, all of these monitoring elements are present in the locker 12.

In addition to the above mentioned monitoring elements 30, the locker 12 further constitutes a set of comfort elements 52. The comfort elements 52 are for assuring a pet 32 inside the locker 12 is not subjected to dangerous conditions. Additionally, they may be used to provide enhanced experience or peace of mind for the user 24. The comfort elements 52 are controlled by the software system 14. The software system 14 utilizes the outputs 34 of the monitoring elements 30 to selectively activate some of the comfort elements 52.

In the preferred embodiment, the comfort elements 52 constitute at least one of:

a) a treat dispenser 54;

b) a self cleaner 56;

c) a plurality of interior lights 58;

d) a plurality of exterior lights 60;

e) a heater 62;

f) a cooling fan 64;

g) an air conditioner 66;

h) an ultraviolet light; and

i) a speaker 70.

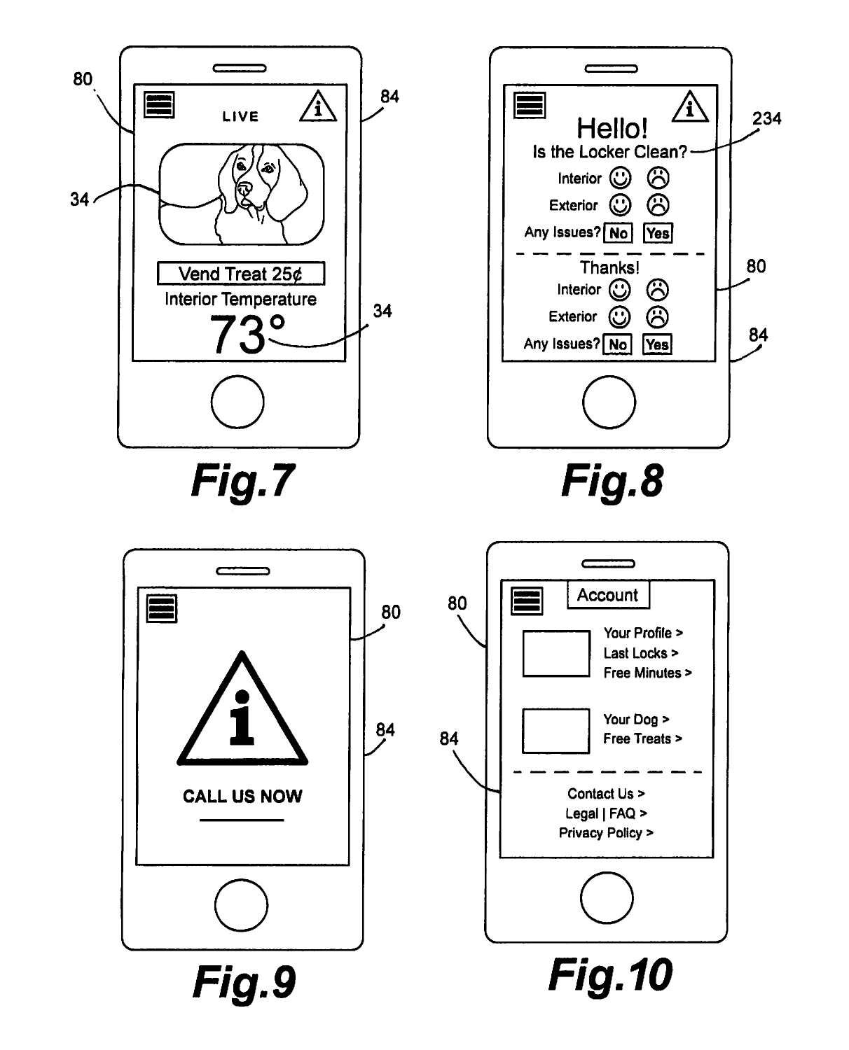

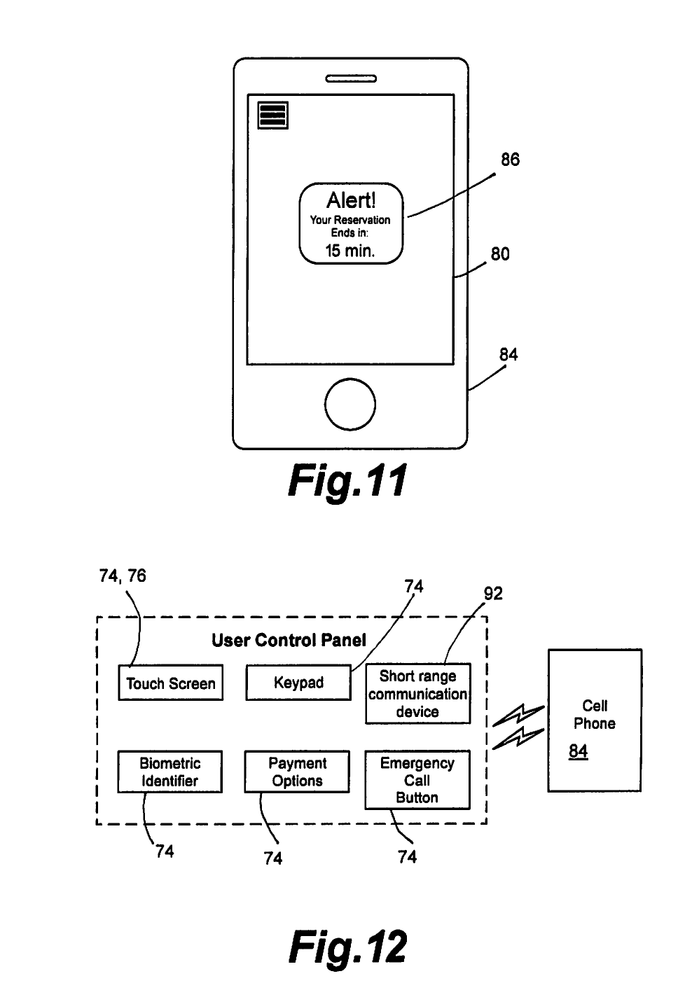

In addition to the comfort elements 52 being controlled according to the outputs 34 of the monitoring elements 30, they may alternately be controlled remotely by a user 24. This is illustrated in FIG. 7.

In a preferred embodiment, the user interface 20 in part constitutes a user control panel 72. The user control panel has an input 74 and a display 76. In one embodiment, these may be the same and take the form of a touchscreen. In alternate embodiments they may be separate. The input 74 communicates to the computer 28, and the display 76 is controlled by the computer 28.

The locker system 10 further constitutes a server 78. The aforementioned communication between the locker 12 and the outside world constitutes communication between the locker 12 and the server 78. The server 78 is capable of issuing commands to be executed by the locker 12.

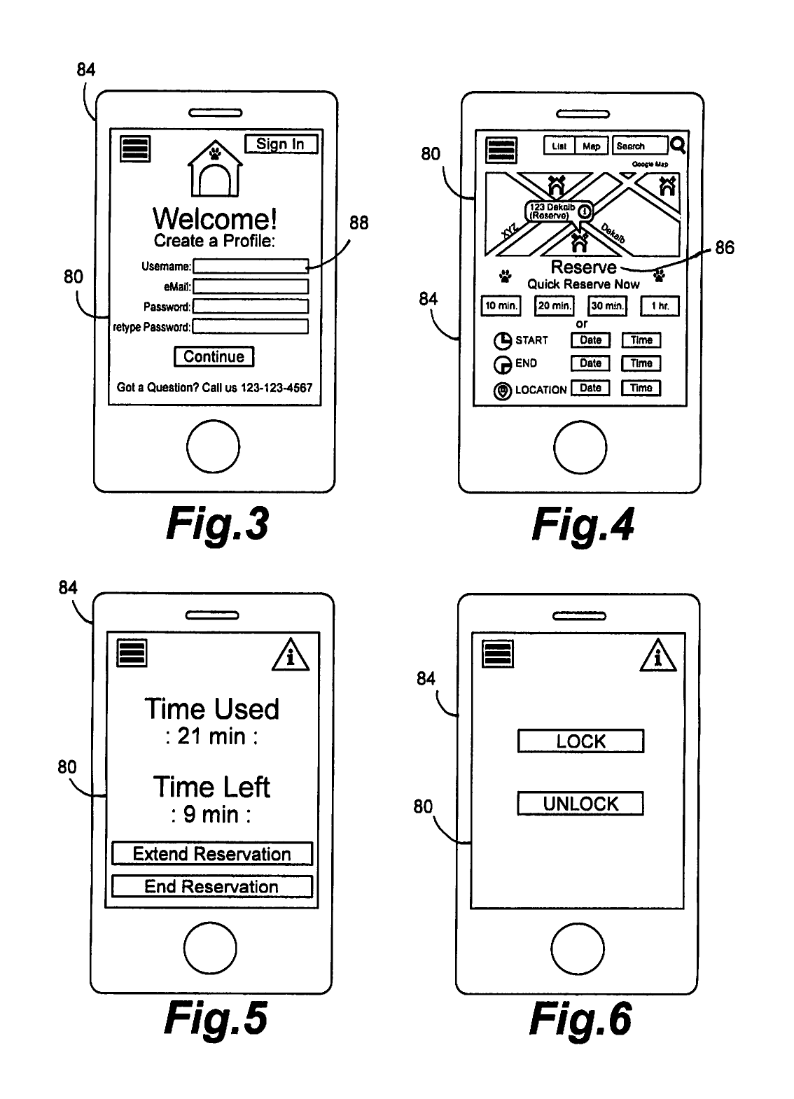

As illustrated in FIGS. 3-10, the server is in communication with a mobile application 80. The mobile application 80 is software installed on a mobile communications device 84 of a user. It is to be understood that in the most common expected use case, the mobile communication device 84 is a cell phone, especially a smartphone. However other devices such as tablet computers, or computer enabled wristwatches might also be utilized. The server relays the outputs 34 of the monitoring elements 30 of the locker 12 to the mobile application 80. As particularly illustrated in FIG. 7, the mobile application 80 is capable of receiving and displaying the outputs 34 of the monitoring elements 30 to a user 24.

In addition the mobile application 80 is capable of communicating to the locker 12 via the server 78. As specifically illustrated in FIG. 6, that communication may include commands to engage or disengage said locking mechanism 18.

Further, the software system 14 is capable of taking a reservation 86. The reservation 86 prevents all but one user from utilizing the locker 12 in a specified timeframe. As illustrated in FIGS. 4 and 5, the mobile application 80 may be utilized to make such a reservation 86.

In the preferred embodiment, the mobile application includes a verification system 88, which verification system 88 is for confirming the identity of the user 24 in interaction with the user interface 20 of the locker 12. The verification system 88 is capable of utilizing a reservation 86 to access a locker 12 that is otherwise prevented from being accessed.

There are multiple possible verification systems 88, which may be available simultaneously for redundancy sake. A first example is where the verification system 88 constitutes a code 90 to be entered manually on the input 74 of the user control panel 72. In a second example of a verification system 88, the user interface 20 further contains a short range communications device 92, and the verification system 88 may alternately utilize the short range communications device 92 to access a locker 12 that is otherwise prevented from being accessed. This is illustrated in FIG. 12. In a preferred embodiment, this would constitute a near field communications system or a bluetooth system, but many possible implementations exist. Thus, the short range communications device 92 cooperates with the mobile application 80 to communicate with said mobile application 80.

Further to the communication system 22 of the locker 12, the communication system ideally constitutes:

a) a first communication system 96; and

b) a second communication system 98.

Such that the first communication system 96 and said second communications system 98 are capable of providing a backup for each other. This backup is necessary to ensure the safety of the pet 32 inside. In one embodiment, the first communication system 96 is a wired internet connection 100, and the second communication system 102 is a wireless internet connection.

Still further to the issue of providing safety for a pet 32, the locker 12 further constitutes a power supply 104; and the power supply 104 is fed by a power source 106. The locker 12 further has a backup battery 108. The backup battery 108 feeds into the power supply 104 when the power source 106 is interrupted.

### Detailed Description of the Method of Using 210 a Locker System 10 for Pets 32.

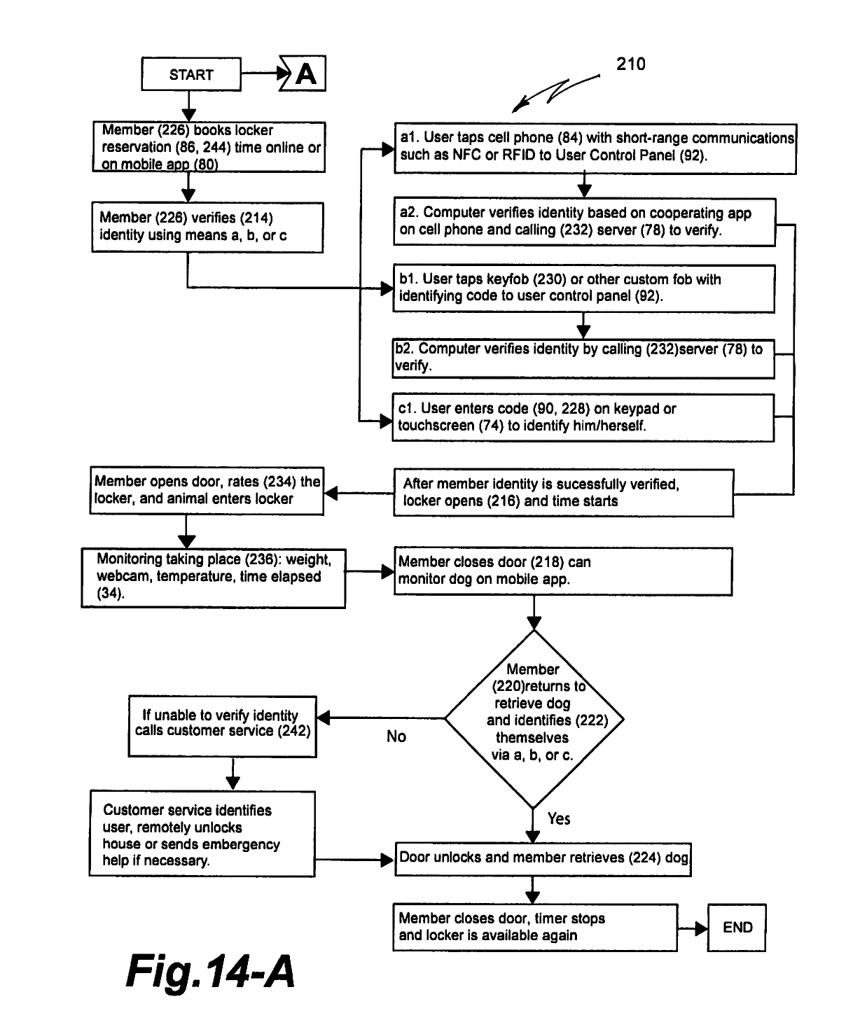

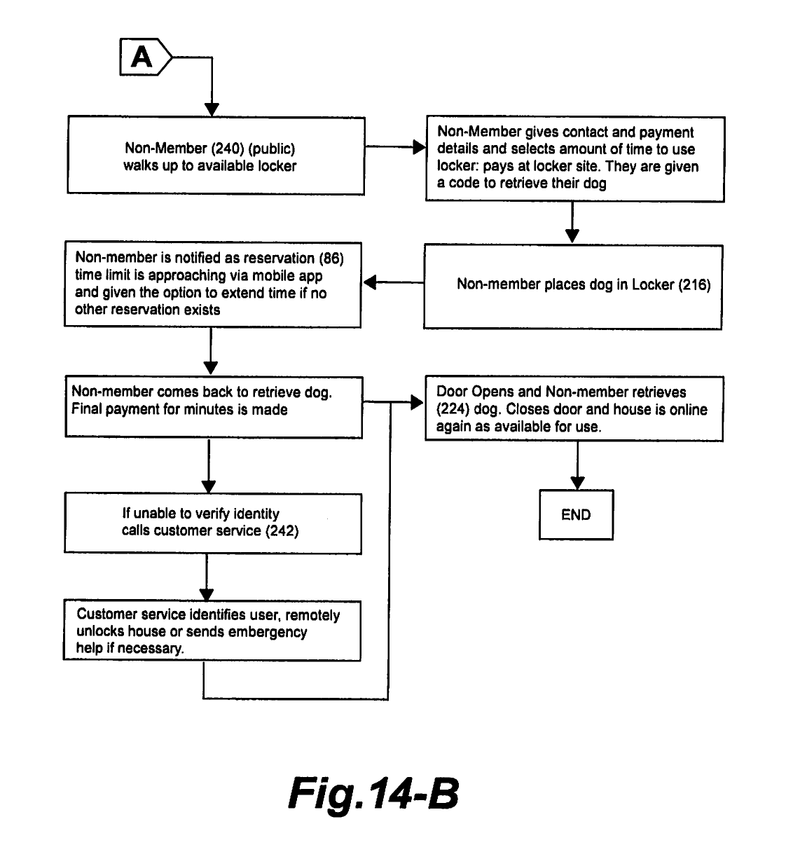

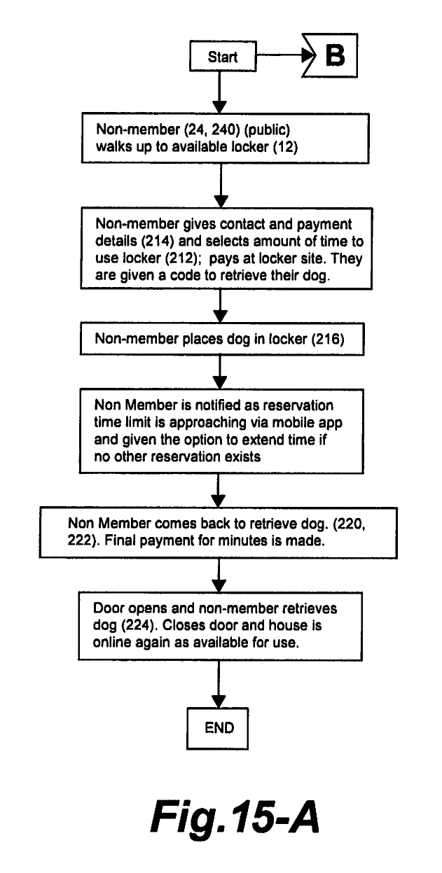

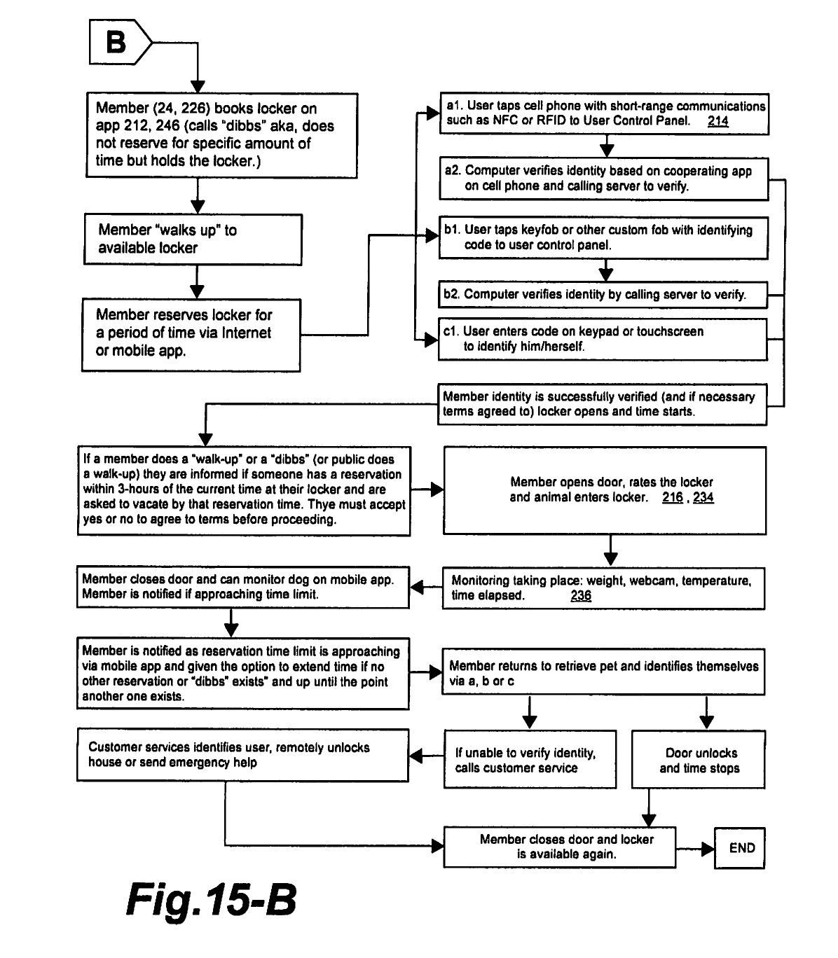

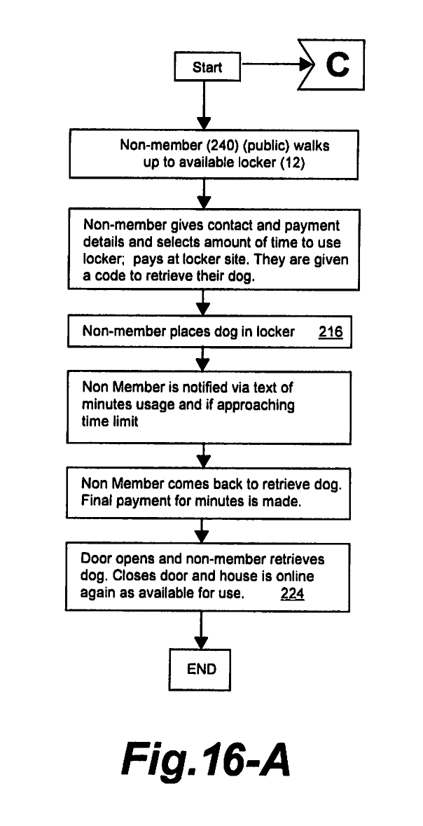

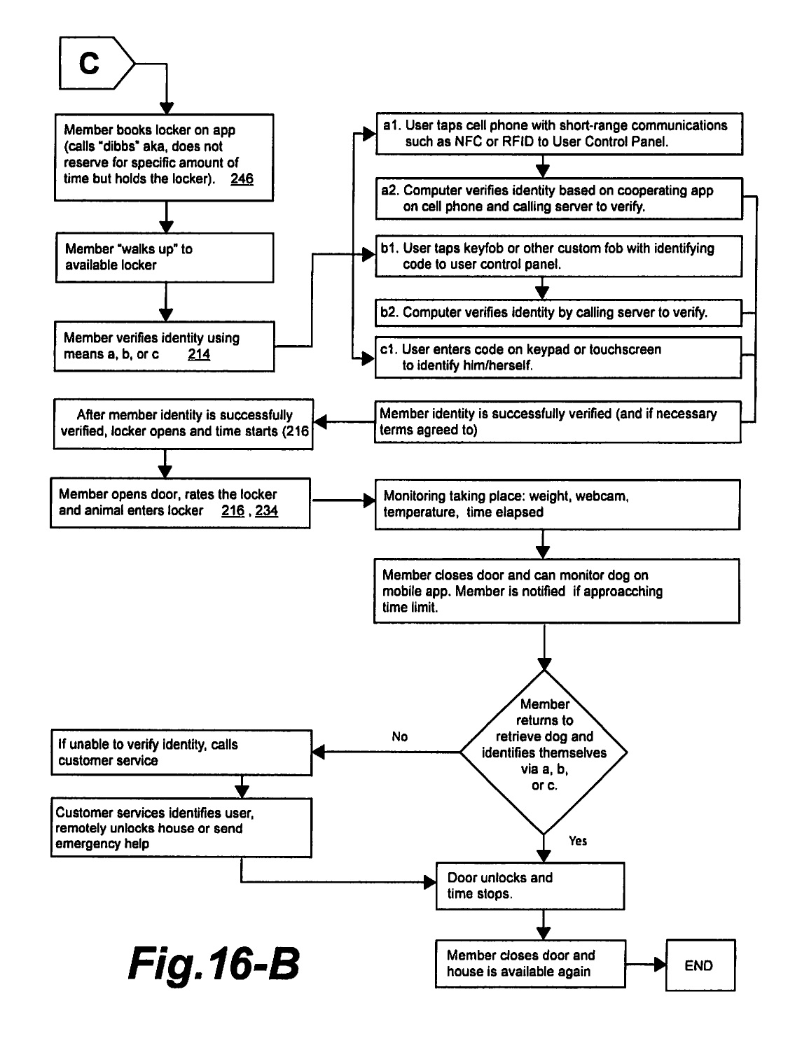

Further to the above description of the locker system 10, disclosed is a corresponding method of using same. This method is disclosed in FIGS. 14-16. For this method 210, the locker system 10 at minimum constitutes:

a) a locker 12;

b) a user interface 20;

c) a plurality of monitoring elements 30; and

d) a software system 14.

The method 210 constitutes the steps of:
1) a user 24 reserving 212 a time period of use of the locker 12;
2) the user 24 identifying themselves 214 via the user interface 20;
3) the user 24 opening 216 the locker 12 and inserting a pet 32 therein;
4) the user 24 closing 218 the locker 12;
5) the user 24 returning 220 at a later time to the locker 12;
6) the user 24 verifying their identity again 222; and
7) the user 24 retrieving 224 their pet 32.

In one version of the method, the user 24 identifying themselves via the user interface 20 constitutes the user 24 verifying their identity 214, 222 as a previously known member 226. In doing this, the step of the user 24 verifying their identity 214 via the user interface 20 is accomplished by means of entering a password 228 or other secret information 90 into said user interface.

Alternately, and further to the previous descriptions of verification, the user interface 20 further constitutes a short-range communications device 92, so that the step of the user 24 verifying their identity 214, 222 via the user interface 20 may additionally be accomplished by the alternate means of utilizing a cell phone 84 with a cooperating short-range communication system. As yet another alternative, the step of the user 24 verifying their identity 214, 222 via the user interface 20 may additionally be accomplished by the user 24 contacting a keyfob 230 or other custom fob with identifying code to the user interface 20. It is to be understood that these verification systems are not mutually exclusive.

To best enable this method, the locker system 10 further constitutes a server 78. The software system 14 is in communication with the server 78. The software system 14 verifies the content of communications from a user's 24 cell phone 84 or fob 230 by calling 232 the server 78 to verify.

Two methodological enhancements are now disclosed for providing a better customer experience. In the first, the steps of the method 210 further constitute a step of the user 24 rating 234 the locker 12 after opening 218 said locker and inserting the pet 32 therein. This is illustrated in FIG. 14-A and FIG. 8. In the second, the steps of the method 210 further constitute a step of the locker system 10 monitoring 236 the pet 32 therein after the pet 32 is inserted 216 therein.

Further to the second enhancement, the monitoring 236 the pet 32 further constitutes the step of communicating the output of the monitoring to the user 24 via the Internet, as illustrated in FIG. 7.

Now disclosed are payment options for member 226 and non-member 240 users. When used by a known member 226, the member 226 has payment information on file, and the member 226 is automatically billed for the time they have utilized after the locker is vacated 224. When the user 24 identifying themselves via the user interface 20 is a non-member 240, the non-member 240 provides contact and payment information via the user interface 20 to verify their identity 214 as a new user.

Due to the live nature of the stored articles, it is necessary for overrides to exist for safety. If a user 24 is unable to re-identify themselves 222, the user 24 is prompted to contact via telephone a human supervisor 242 who can unlock the locker 12.

Finally, disclosed is a pair of reservation systems, either a pre-arranged reservation 244 system or impromptu reservation 246 system. For this, the step of reserving a time period of use of the locker 12 constitutes either:
a) making a pre-arranged reservation 244 in advance of use of said locker; or
b) making an impromptu reservation 246 of time for immediate use of said locker.

In this method, making a pre-arranged reservation 244 in advance of use of the locker 12 has priority over said making an impromptu reservation 246 of time for immediate use of the locker 12. It is also understood that a reservation 244, 246 may cover multiple lockers 12. For instance a reservation at a location with two lockers 12 connected to one another would assure that one of those lockers 12 is available, but not necessarily assure which one. Making a pre-arranged reservation 246 in advance of arrival or use of the locker 12 may only be performed by a previously known member 226. Making an impromptu reservation 246 of time for immediate use of the locker 12 may be accomplished remotely by a previously known member 226 or customer via the use of the mobile application 80.

It will be understood that each of the elements described above, or two or more together, may also find a useful application in other types of constructions differing from the types described above.

While the invention has been illustrated and described as embodiments of a DOG LOCKER/PET LOCKER, accordingly it is not limited to the details shown, since it will be understood that various omissions, modifications, substitutions and changes in the forms and details of the device illustrated and its operation can be made by those skilled in the art without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute characteristics of the generic or specific aspects of this invention.

The invention claimed is:

1. A locker system for pets which comprises:
a) a locker; and
b) a software system;
wherein said locker comprises:
a) at least one chamber;
b) a locking means;
c) a user interface; and
d) a communication means;
wherein said at least one chamber is lockable by said locking means;
wherein said locking means is controlled by said software system;
wherein a user may interface with said software system via said user interface;
wherein said communication means is for communication between said locker and the outside world; and
wherein said software system is capable of communication with the outside world.

2. The locker system of claim 1 wherein said locker further comprises a computer;
wherein said software system controls said computer;
wherein said computer is electronically connected to and controls said locking means;
wherein said computer is capable of being controlled remotely from the outside world via said communication means; and
wherein said computer is capable of being controlled locally via a user interfacing with said user interface.

3. The locker system of claim 2 wherein said locker further comprises a set of monitoring elements;
wherein said set of monitoring elements are for monitoring a pet inside of said chamber of said locker;
wherein said set of monitoring elements are in electronic communication with said computer;
wherein said set of monitoring elements produce outputs; and
wherein said software system controlling said computer is capable of communicating the outputs of said monitoring elements to the outside world.

4. The locker system of claim 3 wherein said monitoring elements comprise a microphone.

5. The locker system of claim 3 wherein said monitoring elements comprise a scale.

6. The locker system of claim 3 wherein said monitoring elements comprise a camera.

7. The locker system of claim 3 wherein said monitoring elements comprise a thermometer.

8. The locker system of claim 3 wherein said monitoring elements comprise a GPS locator.

9. The locker system of claim 3 wherein said monitoring elements comprise a bark detector.

10. The locker system of claim 3 wherein said monitoring elements comprise a motion detector.

11. The locker system of claim 3 wherein said monitoring elements comprise a door closure detector.

12. The locker system of claim 3 wherein said locker further comprises a set of comfort elements;
wherein said comfort elements are for assuring a pet inside said locker is not subjected to dangerous conditions;
wherein said comfort elements are controlled by said software system; and
wherein said software system utilizes the outputs of said monitoring elements to selectively activate said comfort elements.

13. The locker system of claim 12 wherein said comfort elements comprise a treat dispenser.

14. The locker system of claim 12 wherein said comfort elements comprise a self cleaner.

15. The locker system of claim 12 wherein said comfort elements comprise a plurality of interior lights.

16. The locker system of claim 12 wherein said comfort elements comprise a plurality of exterior lights.

17. The locker system of claim 12 wherein said comfort elements comprise a heater.

18. The locker system of claim 12 wherein said comfort elements comprise a cooling fan.

19. The locker system of claim 12 wherein said comfort elements comprise an air conditioner.

20. The locker system of claim 12 wherein said comfort elements comprise an ultraviolet light.

21. The locker system of claim 12 wherein said comfort elements comprise a speaker.

22. The locker system of claim 12 wherein said user interface comprises a user control panel;
wherein said user control panel comprises an input and a display;
wherein said input communicates to said computer; and
wherein said display is controlled by said computer.

23. The locker system of claim 22 wherein said locker system further comprises a server;
wherein said communication between said locker and the outside world constitutes communication between said locker and said server; and
wherein said server is capable of issuing commands to be executed by said locker.

24. The locker system of claim 23 wherein said server is in communication with a mobile application;
wherein said mobile application is software installed on a mobile communications device of a user;
wherein said server relays said outputs of said monitoring elements to said mobile application; and
wherein said mobile application is capable of receiving and displaying said outputs of said monitoring elements to a user.

25. The locker system of claim 24 wherein said mobile application is capable of communicating to said locker via said server; and
wherein said communication may include commands to engage or disengage said locking means.

26. The locker system of claim 25 wherein said software system is capable of taking a reservation; and
wherein said reservation prevents all but one user from utilizing said locker in a specified timeframe.

27. The locker system of claim 26 wherein said mobile application may be utilized to make said reservation.

28. The locker system of claim 27 wherein said mobile application includes a verification means; and
wherein said verification means is for confirming the identity of the user in interaction with said user interface of said locker.

29. The locker system of claim 28 wherein said verification means is capable of utilizing said reservation to access a locker that is otherwise prevented from being accessed.

30. The locker system of claim 29 wherein said verification means comprises a code to be entered manually on said input.

31. The locker system of claim 30 wherein said user interface further comprises a short range communications device; and
wherein said verification means may alternately utilize said short range communications device to access a locker that is otherwise prevented from being accessed.

32. The locker system of claim 31 wherein said short range communications device cooperates with said mobile application to communicate with said mobile application.

33. The locker system of claim 3 wherein said monitoring elements comprise a pressure sensor.

34. The locker system of claim 22 wherein said communication means further comprises:
a) a first communication means; and
b) a second communication means; and
wherein said first communication means and said second communications means are capable of providing a backup for each other.

35. The locker system of claim 34 wherein said first communication means is a wired internet connection; and
wherein said second communication means is a wireless internet connection.

36. The locker system of claim 34 wherein said locker further comprises a power supply; and
wherein said power supply is fed by a power source.

37. The locker system of claim 36 wherein said locker further comprises a backup battery; and
wherein said backup battery feeds into said power supply when said power source is interrupted.

38. A method of using a locker system for pets wherein said locker system comprises:
a) a locker;
b) a user interface;
c) a plurality of monitoring elements; and
d) a software system
wherein the method comprises the steps of:
1) a user reserving a time period of use of said locker;
2) said user identifying themselves via said user interface;
3) said user opening said locker and inserting a pet therein;
4) said user closing said locker;
5) said user returning at a later time to said locker;
6) said user verifying their identity again; and
7) said user retrieving their pet.

39. The method of claim 38 wherein said user identifying themselves via said user interface constitutes said user verifying their identity as a previously known member.

40. The method of claim 39 wherein said step of said user verifying their identity via said user interface is accomplished by means of entering a password or other secret information into said user interface.

41. The method of claim 40 wherein said user interface further comprises a short-range communications device; and
wherein said step of said user verifying their identity via said user interface may additionally be accomplished by an alternate means of utilizing a cell phone with a cooperating short-range communication system.

42. The method of claim 41 wherein said step of said user verifying their identity via said user interface may additionally be accomplished by said user contacting a keyfob or other custom fob with identifying code to said user interface.

43. The method of claim 42 wherein said locker system further comprises a server;
wherein said software system is in communication with said server; and
wherein said software system verifies the content of communications from said cell phone or said fob by calling said server to verify.

44. The method of claim 38 wherein said steps further comprise a step of the user rating said locker after opening said locker and inserting the pet therein.

45. The method of claim 38 wherein said steps further comprise a step of said locker system monitoring the pet therein after the pet is inserted therein.

46. The method of claim 45 wherein said monitoring the pet further comprises the step of communicating the output of said monitoring to said user via the internet.

47. The method of claim 39 wherein said member has payment information on file; and
wherein said member is automatically billed for the time they have utilized after the locker is vacated.

47. The method of claim 38 wherein said user identifying themselves via said user interface is for a non-member; and
wherein said non-member provides contact and payment information via said user interface to verify their identity as a new user.

48. The method of claim 47 wherein a user who is unable to re-identify themselves is prompted to contact via telephone a human supervisor who can unlock the locker.

49. The method of claim 39 wherein a user who is unable to re-identify themselves is prompted to contact via telephone a human supervisor who can unlock the locker.

50. The method of claim 38 wherein said step of reserving a time period of use of said locker constitutes either:
a) making a pre-arranged reservation in advance of use of said locker; or
b) making an impromptu reservation of time for immediate use of said locker.

51. The method of claim 50 wherein said making a pre-arranged reservation in advance of use of said locker has priority over said making an impromptu reservation of time for immediate use of said locker.

52. The method of claim 51 wherein said making a pre-arranged reservation in advance of arrival or use of said locker may only be performed by a previously known member.

53. The method of claim 52 wherein said making an impromptu reservation of time for immediate use of said locker may be accomplished remotely by a previously known member or customer via the use of a mobile application.
